(19) United States
(12) Patent Application Publication
(10) Pub. No.: US 2013/0025123 A1
(43) Pub. Date: Jan. 31, 2013

(54) WORKING A VANE ASSEMBLY FOR A GAS TURBINE ENGINE

(71) Applicants: Thomas A. Vetere, Bedford, TX (US); Michael L. Miller, Euless, TX (US)

(72) Inventors: Thomas A. Vetere, Bedford, TX (US); Michael L. Miller, Euless, TX (US)

(73) Assignee: UNITED TECHNOLOGIES CORPORATION, Hartford, CT (US)

(21) Appl. No.: 13/194,127

(22) Filed: Jul. 29, 2011

(51) Int. Cl. B23P 6/00; B23P 17/00

(52) U.S. Cl. 29/888; 29/889.1

(57) ABSTRACT

A method of working a vane assembly for a gas turbine engine involves a collar and an engine operated cooling baffle. The collar is connected to the cooling baffle and installed into the interior cavity of the vane assembly. A braze is applied to both a portion of the collar that interfaces with the cooling baffle and to a second portion of the collar that interfaces with the vane assembly. In one embodiment, the connection between the replacement collar and both the cooling baffle and vane assembly is accomplished by fitting the cooling baffle into the collar and by slipping a portion of the cooling baffle with a smaller cross-sectional area though the collar.

### BACKGROUND

The present invention relates to gas turbine engines, and more particularly to the manufacture and assembly of components of vane assemblies of a gas turbine engine.

The compressor and turbine sections of gas turbine engines have rotor elements that are separated from one another by vane assemblies. The vane assemblies comprise stator platforms and airfoils that guide the flow of working gases within the turbine and compressor sections. Especially in the turbine section, the temperature of working gases passing through the vane assemblies necessitates that the vane assemblies be cooled by air that is passed through components and features such as film cooling orifices and cooling baffles.

During operation of the gas turbine engine, the vane assemblies can become worn, damaged, or otherwise degraded such that a repair or replacement is required. In most cases, it is desirable from a regulatory and cost standpoint to repair the vane assemblies rather than replace them.

Repair of the vane assemblies is generally conducted by first removing the baffles from the vane assembly. The baffles are then machined, cleaned, inspected, and otherwise repaired in a line process that is separate from the repair of the remainder of the vane assembly. Thus, the baffles undergo a separate repair process from the remainder of the vane assembly. After these two separate processes are completed, the baffles are reinserted into the remainder of the vane assembly, and affixed thereto, typically by welding. After being reassembled, the vane assembly then undergoes several additional repair processes.

Unfortunately, repairing the baffles separately from the vane assembly increases the time required for the repair process and introduces unwanted complexity into the process. The increased time and complexity increases the overall cost of the repair for the vane assemblies making repair a less attractive alternative to replacement.

### SUMMARY

A method of working a vane assembly for a gas turbine engine involves a collar and an engine operated cooling baffle. The collar is connected to the cooling baffle and installed into the interior cavity of the vane assembly. A braze is applied to both a portion of the collar that interfaces with the cooling baffle and to a second portion of the collar that interfaces with the vane assembly. In one embodiment, the connection between the replacement collar and both the cooling baffle and vane assembly is accomplished by fitting the cooling baffle into the collar and by slipping a portion of the cooling baffle with a smaller cross-sectional area though the collar.

In one embodiment, the collar comprises a replacement collar and the cooling baffle comprises an engine operated cooling baffle. An engine operated collar is destroyed by removal from an engine operated cooling baffle, and the engine operated cooling baffle is removed from an interior cavity of the vane assembly. The replacement collar is then connected and brazed to engine operated cooling baffle and vane assembly.

An assembly for a gas turbine engine includes a vane segment and a cooling baffle. The vane segment has a first platform, a second platform, and one or more airfoils that extend between the first platform and the second platform. Each airfoil has a hollow interior cavity accessible by an opening in the first platform. The cooling baffle extends within the hollow interior of each airfoil. Each cooling baffle includes a collar that is brazed to both a main body of the cooling baffle and to the opening in the first platform.

### BRIEF DESCRIPTION OF THE DRAWINGS

FIG. 1A is a perspective view of a vane assembly.

FIG. 1B is a sectional view of the vane assembly of FIG. 1A showing a cooling baffle, an airfoil, and a first and second platforms.

FIG. 2 is a flow chart of a manufacturing method according to the present invention.

FIGS. 3A-3C are perspective views of a main body of the cooling baffle being slip fit into a collar.

### DETAILED DESCRIPTION

The present invention describes a working of components of a vane assembly. Thus, the present application is applicable to any forming of the product. However, the application is particularly useful to repairs where components of the vane assembly have become worn or degradated during operation of a gas turbine engine. Additionally, articles that results from the working are described.

The vane assembly is worked according to the following process. One or more cooling baffles are cleaned, a collar for each cooling baffle is fabricated and connected to the remainder of the cooling baffle, and the collars and the cooling baffles are installed into the vane assembly. Together the entire vane assembly including the collar, the cooling baffle, and a vane segment that houses the baffle and collar are brazed, inspected, coated, and treated as desired in a concurrent process. By brazing, inspecting, coating, and treating the replacement collar, the cooling baffle, and the vane segment simultaneously, the cost and time required for the working is decreased and the complexity of the working is decreased as a single line can be used to repair all components of the vane assembly.

The method of working is also applicable to a repair where one or more engine operated cooling baffles are removed from the remainder of the vane assembly. To remove the engine operated cooling baffles, an engine operated collar of each cooling baffle is destroyed by electric discharge machining. The remainder of the cooling baffle is then removed from the remainder of the vane assembly. The cooling baffles are cleaned, a replacement collar for each engine operated cooling baffle is fabricated and connected to the remainder of the engine operated cooling baffle, and the replacement collars and the cooling baffles are reinstalled back into the vane assembly. Together the entire vane assembly including the replacement collar, the original cooling baffle, and a vane segment that houses the baffle and collar are brazed, inspected, coated, and treated as desired in a concurrent repair process.

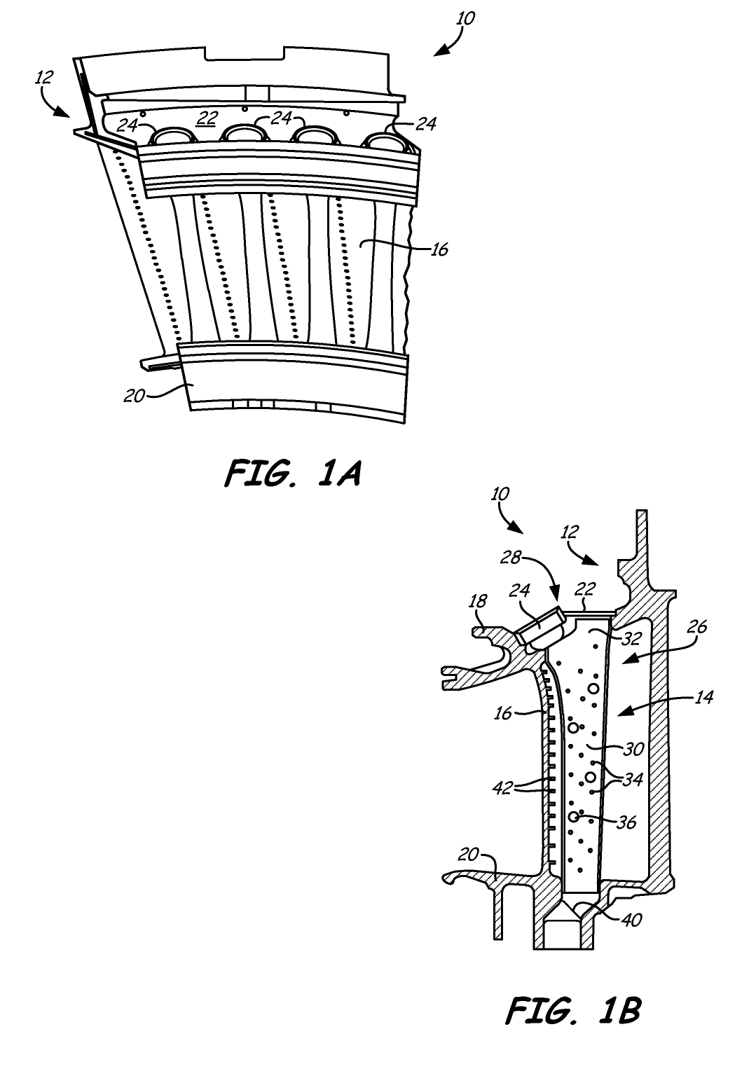

FIG. 1A is a perspective view of a vane assembly 10 for use in a gas turbine engine. FIG. 1B is a sectional view of the vane assembly 10 through one of the airfoils showing the interior thereof. The vane assembly 10 includes a vane segment 12 and a cooling baffle 14. The vane segment 12 includes airfoils 16, a first platform 18, a second platform 20, a plate 22, and rings 24. Airfoils 16 each have a hollow interior cavity 26. The first platform 18 forms an opening 28 to each interior cavity 26. The cooling baffle 14 includes a main body 30, a collar 32, cooling orifices 34, and standoffs 36.

The construction and operation of vane assemblies 10 such as those described are known in the art, and are described, for example, in U.S. Pat. No. 7,798,773, which is incorporated herein by reference. The vane segment 12 is arcuate in shape, and several such vane segments 12 can be assembled together within the gas turbine engine to extend around the engine centerline thereof in the compressor or turbine sections.

The cooling baffles 14 are disposed in and connected to each vane segment 12. In particular, the cooling baffles 14 extend within the airfoils 16. The airfoils 16 extend between and are connected to the first platform 18 and the second platform 20. In the embodiment shown, the first platform 18 has an arcuate extent and is disposed radially outward of the arcuate second platform 20. The plate 22 and rings 24 are disposed adjacent to the cooling baffles 14. Thus, the plate 22 extends over the opening 28 in the first platform 18 and connects to the rings 24. In the embodiment shown in FIGS. 1A and 1B, each ring 24 is disposed adjacent to the top opening of the hollow cooling baffles 14. The rings 24 are also connected to the first platform 18 and the plate 22. As will be discussed subsequently, the rings 24 allow cooling airflow to enter the cooling baffle 14 and the vane assembly 10 while the plate 22 provides a seal for the interior cavity 26 of each airfoil 16.

As shown in FIG. 1B, each cooling baffle 14 is hollow and extends within the hollow interior cavity 26 of each of the airfoils 16. The main body 30 of each cooling baffle 14 extends generally radially within the interior cavity 26 to the second platform 20. The main body 30 has a cross-sectional area that decreases in size the closer the main body 30 extends toward the second platform 20. The collar 32 is positioned on and connected to the outer radial portion of the main body 30 (the portion of the main body 30 that has the largest cross-sectional area). The collar 32 is disposed adjacent the ring 24 and has an outer surface that is brazed to the first platform 18 in the opening 28. As will be discussed in further detail subsequently, the collar 32 is positioned on and connected to the main body 30 by, for example, a slip fit connection, a light tack weld, adhesives, and/or other connection means. More particularly, a radially inner surface of the collar 32 is then brazed to the main body 30. Thus, the collar 32 is connected to and brazed onto both the main body 30 (the remainder of the cooling baffle 14) and the first platform 18 of the vane segment 12.

The hollow cooling baffles 14 have cooling orifices 34 therein. The standoffs 36 project from the surface of the main body 30 and create space between the cooling baffle 14 and the interior wall of the airfoil 16 to allow a path for airflow therebetween in the interior cavity 26. Airflow is supplied to the interior (not shown) of the cooling baffle 14 by a supply duct (not shown) and enters the cooling baffle 14 through the ring 24. The cooling air exits the baffle from supply duct 40 situated adjacent a radially inner open end of the cooling baffle 14. The airflow is directed through the cooling orifices 34 as it flows through cooling baffle 14. Cooling orifices 34 direct airflow against the interior wall of the airfoil 16. Disposed generally to interface the cooling orifices 34 and extend from the interior wall of the airfoil 16, are a plurality of fins 42. The fins 42 form disturbances in the airflow from the cooling orifices 34 to provide better cooling for the airfoil 16.

The vane assembly 10 shown in FIGS. 1A and 1B is of a type suitable for use in a turbine section of gas turbine engines. Cooling openings (not numbered) are formed in the vane segment 20 to direct a cooling fluid (e.g., bleed air) as desired. The airfoils 16 and cooling baffles 14 can be formed of high temperature compatible sheet metal (e.g., from a nickel or cobalt-based superalloy), by stamping and then attached to the first and second platforms 18 and 20 by brazing, welding or other suitable techniques. As will be discussed, treatments and coatings (e.g., thermal barrier coatings) can be applied to surfaces of the vane assembly 10.

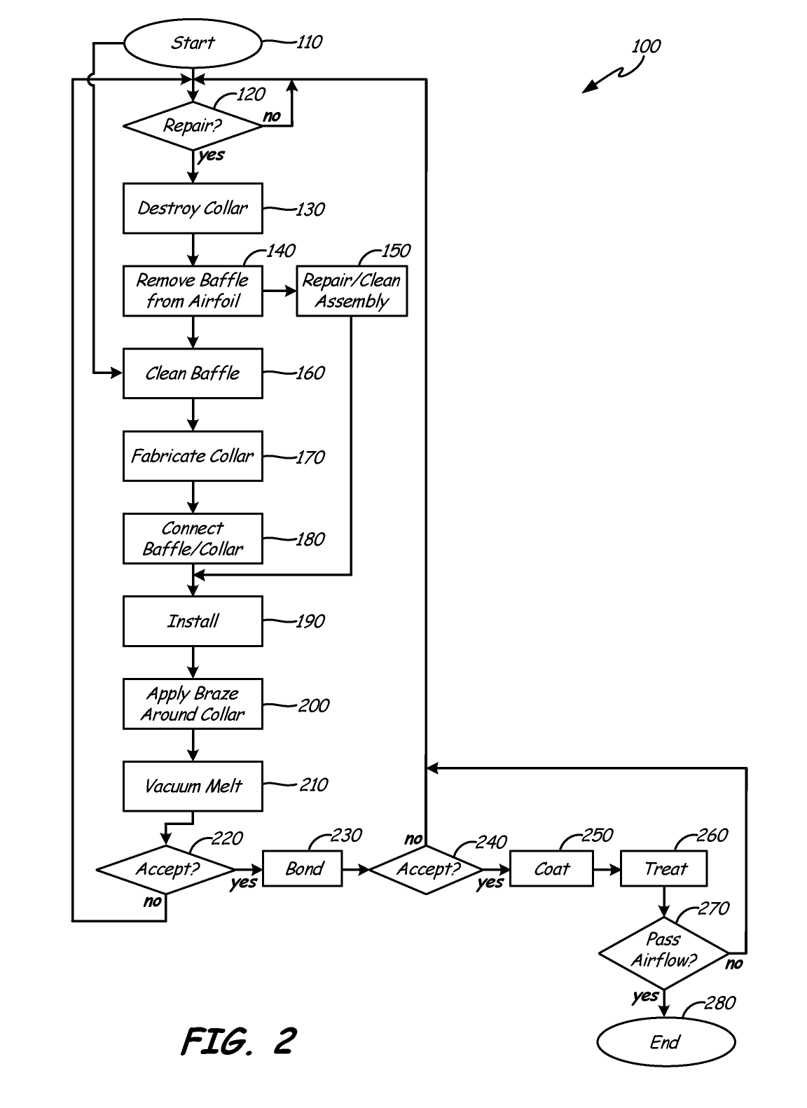

FIG. 2 is a flow chart of a manufacturing method 100 for the engine operated vane assembly 10. From initial start 110, the method 100 proceeds to inspection step 120, which applies if the method comprises a repair. If the method 100 does not apply to a repair method 100 bypasses step 120 and proceeds to step 160.

At step 120, if non-repairable damage is found the vane assembly 10 is scrapped without the working being performed and the method 100 is begun again with a different engine operated vane assembly 10.

After step 120, the method 100 proceeds to step 130 where, if a repair is being performed, the engine operated collar 32 of each engine operated cooling baffle 14 is destroyed. Because the cooling baffles 14 are often welded in place, grinding (e.g., using carbide or oxide bun techniques), electric discharge machining (EDM), or other machining techniques can be used to break existing welds in order to remove the cooling baffles 14 from the vane assembly 10.

The destruction of the engine operated collar 32 allows the remainder of each engine operated cooling baffle 14, comprising the main body 30, to be removed from the remainder of the vane assembly 10 (the vane segment 12) in step 140. After removal of the engine operated cooling baffles 14, the vane segment 12 is repaired and cleaned at step 150 using known techniques. For example, the vane segment 12 undergoes a braze crack repair and dimension restoration. Additionally, the vane segment 12 is cleaned by, for example, silicone carbide blasting and/or a solvent wipe to remove smut.

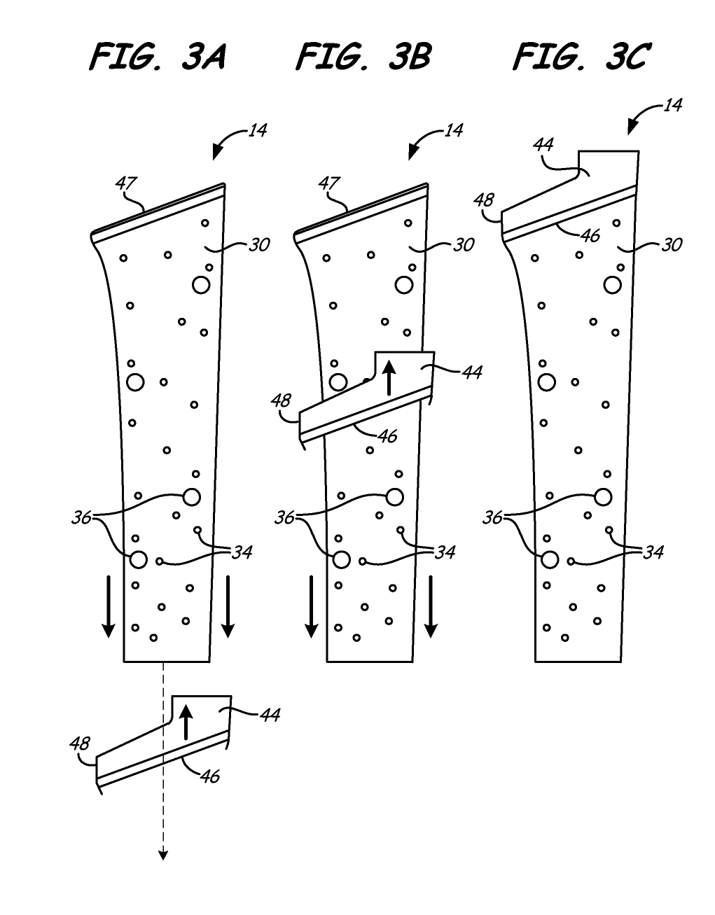

At step 160, the engine operated cooling baffle 14 (and optionally vane segment 12 if a repair is not being performed) undergoes a clean. A collar 44 (FIGS. 3A-3C) is fabricated at step 170. In the case of a repair, the collar 44 comprises a replacement part. Although the fabrication of the replacement collar 44 is illustrated as step 170 in the method 100, the fabrication of the collar 44 can occur at any prior point in the method. In one embodiment, the collar 44 is fabricated by stamping sheet metal to a desired size and shape to connect to and fit on the cooling baffle 14 and the opening 28 in the first platform 18.

Each collar 44 is connected to the engine operated cooling baffle 14 at step 180. In one embodiment, the collar 44 is connected to the cooling baffle 14 by slip fitting the baffle 14 into the replacement collar 44. In another embodiment, the collar 44 is connected to the cooling baffle 14 by a light tack weld between the collar 44 and the cooling baffle 14. In yet another embodiment, the collar 44 is connected to the cooling baffle 14 by both slip fitting the cooling baffle 14 into the replacement collar 44 and by tack welding the replacement collar 44 and the cooling baffle 14. In other embodiments, known forms of creating a connection such as adhesives can be used to connect the collar 44 to the cooling baffle 14.

After connecting the collar 44 to the cooling baffle 14, the method 100 proceeds to step 190 where the collar 44 and the cooling baffle 14 are installed into the interior cavity 26 of the vane assembly 10. Upon or prior to installation, a braze material is applied at step 200 to both a portion of the collar 44 that interfaces with the cooling baffle 14 and to a second portion of the collar 44 that interfaces with the vane assembly 10. In particular, the braze material is applied to the outer surface of the collar 44 that interfaces with the first platform 18 in the opening 28 (FIGS. 1A and 1B).

From step 200, the method 100 moves to step 210. At step 210, the assembled vane assembly 10, including the cooling baffle 14 and collar 44 are placed in an elevated temperature environment, such as a vacuum furnace, so that the braze material begins to melt. After the braze material begins to melt, inspection of the vane assembly 10 occurs at step 220. Specifically, the coverage of the braze material between the various parts is reviewed to determine if enough braze material has been applied. If the coverage of the braze material is not deemed to be acceptable, the vane assembly 10 is removed from the elevated temperature environment and scrapped. In such an instance, the method 100 would begin again with a different vane assembly 10. If the coverage of the braze material is deemed acceptable the method 100 moves to step 230.

At step 230, the assembled vane assembly 10 is bonded. More particularly, the cooling baffle 14, the collar 44, and the vane segment 12 are bonded together using a process such as diffusion bonding. Diffusion bonding is known in the art and is described, for example, in U.S. Pat. Nos. 5,145,105, 4,250,229, and 4,010,530, which are incorporated herein by reference.

After bonding, the method 100 moves to an inspection step 240. The inspection step 240 can include fluorescent penetrant inspection to determine the existence of cracks in the vane assembly 10. Fluorescent penetrant inspection utilizes dyes, powders, and/or fluorescent penetrants to find cracks and other flaws in the surfaces of workpieces. Generally, the penetrant material is infiltrated into the cracks of a workpiece and after the bulk of the material is wiped away, the residual material which is remaining in the crack is sought out optically. Fluorescent penetrant inspection techniques are described in U.S. Pat. Nos. 4,610,157, 6,427,544, and 6,683,641, which are incorporated herein by reference. If unacceptable cracks are discovered the vane assembly 10 is scrapped. In such an instance, the method 100 would begin again with a different vane assembly 10. If the size and/or number of cracks are deemed acceptable the method moves to step 250.

At step 250, a coating is applied to the exterior of the vane assembly 10. The coating, such as an aluminide, protects against corrosion and, in some embodiments, serves as a high temperature thermal barrier. The cooling baffle 14 is not coated at step 250, thus the interior cavity 26 (FIG. 1B) of each airfoil 16 is masked to prevent the coating from entering. The method 100 proceeds from step 250 to step 260 where the vane assembly 10 is heat treated to restore the material properties of the vane assembly 10 components to specification.

After step 260, the vane assembly 10 undergoes an airflow inspection at step 270. The inspection determines if a sufficient amount of airflow (neither too large an amount or too small an amount of airflow) can pass through the vane assembly 10. If the airflow is not as desired the vane assembly 10 is scrapped. In such an instance, the method 100 would begin again with a different engine operated vane assembly 10. If the airflow is acceptable, the method moves to step 280 and the repair is complete. The vane assembly 10 is then ready for reinstallation into the gas turbine engine.

FIGS. 3A-3C show one embodiment where the collar 44 is connected to and positioned on the engine operated cooling baffle 14. In particular, as illustrated in FIGS. 3A-3C the collar 44 is connected to the cooling baffle 14 by fitting the cooling baffle 14 into the collar 44. As shown in FIG. 3A, this is accomplished by positioning the hollow collar 44 below a portion of the cooling baffle 14 with a smaller cross-sectional area (i.e., an inner portion of the main body 30). The cooling baffle 14 is then slipped though the hollow collar 44.

As shown in FIG. 3C, the upper portion of the main body 30 of the cooling baffle 14 has a slightly larger cross-sectional area than the collar 44. Thus, an outer surface 47 of the main body 30 and an inner surface 46 of the collar 44 interface and overlap to connect. The braze material is applied to the outer surface 47 of the cooling baffle 14 and/or the inner surface 46 of the collar 44 prior to, during, or after the slip fit connection. Additionally, the braze material is applied to an outer surface 48 of the collar 44, which interfaces with the first platform 18 in the opening 28 (FIG. 1B). In one embodiment, the brazing of the collar 44 to the cooling baffle 14 and the brazing of the collar 44 to the vane assembly 10 occur simultaneously.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of manufacturing an assembly for a gas turbine engine, the method comprising:
connecting a collar to a cooling baffle;
installing the collar and the cooling baffle into an interior cavity of a vane assembly; and
applying a braze to both a first surface of the collar that interfaces with the cooling baffle and to a second surface of the collar that interfaces with the vane assembly.

2. The method of claim 1, wherein the cooling baffle comprises an engine operated part and the collar comprises a replacement part.

3. The method of claim 2, further comprising:
destroying an engine operated collar of the cooling baffle;
removing the cooling baffle from the interior cavity of the vane assembly;
bonding the collar, the cooling baffle, and the vane assembly after brazing;
coating exterior surfaces of the vane assembly;
heating the cooling baffle and the vane assembly to restore desired material properties; and
passing an airflow through the cooling baffle and the vane assembly.

4. The method of claim 3, further comprising inspecting the cooling baffle and the vane assembly after the bonding of the replacement collar, the cooling baffle, and the vane assembly.

5. The method of claim 3, further comprising:
melting the braze joining both the collar to the cooling baffle and the collar to the vane assembly; and
inspecting the braze for sufficient coverage after the melting of the braze.

6. The method of claim 1, wherein the brazing of the collar to the cooling baffle and brazing the collar to the vane assembly occurs simultaneously.

7. The method of claim 1, wherein the collar is connected to the cooling baffle by slip fitting the engine operating baffle into the collar.

8. The method of claim 1, wherein the collar is connected to the cooling baffle by a tack weld between the collar and the cooling baffle.

9. The method of claim 1, wherein the collar is connected to the cooling baffle by slip fitting the cooling baffle into the collar and by tack welding the collar and the cooling baffle.

10. A method of repairing a vane assembly for a gas turbine engine, the method comprising:
destroying an engine operated collar of an engine operated cooling baffle;
removing the engine operated cooling baffle from an interior cavity of a vane assembly;
fitting the engine operated cooling baffle into the replacement collar by slipping a portion of the engine operated cooling baffle with a smaller cross-sectional area though the collar;
installing the replacement collar and the engine operated cooling baffle into the interior cavity of the vane assembly; and
applying a braze to both a first surface of the replacement collar that interfaces with the engine operated cooling baffle and to a second surface of the replacement collar that interfaces with the vane assembly.

11. The method of claim 10, wherein the both the engine operated cooling baffle and the vane assembly are cleaned separately prior to installation.

12. The method of claim 10, further comprising:
bonding the replacement collar, the engine operated cooling baffle, and the vane assembly after brazing;
coating exterior surfaces of the vane assembly;
heating the engine operated cooling baffle and the vane assembly to restore desired material properties; and
passing airflow through the engine operated cooling baffle and the vane assembly.

13. The method of claim 12, further comprising inspecting the engine operated cooling baffle and the vane assembly after the bonding of the replacement collar, the engine operated cooling baffle, and the vane assembly.

14. The method of claim 12, further comprising:
melting the braze joining both the replacement collar to the engine operated cooling baffle and the replacement collar to the vane assembly; and
inspecting the braze for sufficient coverage after the melting of the braze.

15. The method of claim 10, wherein the brazing of the replacement collar to the engine operated cooling baffle and the replacement collar to the vane assembly occurs simultaneously.

16. An assembly for a gas turbine engine comprising:
a vane segment having a first platform, a second platform, and one or more airfoils that extend between the first platform and the second platform, each airfoil has a hollow interior cavity accessible by an opening in the first platform; and
a cooling baffle extending within the hollow interior of each airfoil, each cooling baffle including a collar that is brazed to both a main body of the cooling baffle and to the first platform in an opening.

17. The assembly of claim 16, wherein the collar is disposed at a radially outward end of the main body of the baffle.

18. The assembly of claim 16, wherein the braze extends along both an inner radial surface of the collar and an outer surface of the collar.

19. The assembly of claim 16, wherein a tack weld connects the collar to the main body of the cooling baffle.

20. The assembly of claim 16, wherein the main body of the cooling baffle comprises repaired part and the collar comprises a newly fabricated part.
